(19) United States
(12) Patent Application Publication
(10) Pub. No.: US 2015/0227692 A1
(43) Pub. Date: Aug. 13, 2015

(54) PATIENT-GOVERNED HEALTHCARE INFORMATION DATABASE ENVIRONMENT

(71) Applicant: FAHEEM AHMED, Cupertino, CA (US)

(72) Inventor: FAHEEM AHMED, Cupertino, CA (US)

(73) Assignee: SAP AG, Walldorf (DE)

(21) Appl. No.: 14/250,159

(22) Filed: Apr. 10, 2014

Related U.S. Application Data
(60) Provisional application No. 61/938,457, filed on Feb. 11, 2014.

(51) Int. Cl. G06F 19/00

(52) U.S. Cl. CPC G06F 19/322

(57) ABSTRACT

Embodiments relate to a patient-governed healthcare information database environment. The environment provides a central repository for receiving healthcare and related information of a patient, facilitating access by a plurality of authorized consumers (e.g. medical providers) of that information. The environment allows dynamic modification of the database to include many types of information, including data from smart devices, patient activity logs, and responses to customized assessments created by the patient or others. The environment also allows dynamic mining of database information according to flexible queries specifying parameters determined by the consumer of the healthcare information. Access to other patient environments may be granted, such that database modification permits data mining for patient cohorts sharing common characteristics. Some embodiments allow dynamic interaction between the environment and a provider, for example to issue an alert based upon database content (e.g. a medication log not timely updated), or to modify patient behavior via gamification.

### CROSS-REFERENCE TO RELATED APPLICATION

The instant nonprovisional patent application claims priority to the U.S. Provisional Patent Application No. 61/938,457, filed Feb. 11, 2014 and incorporated by reference in its entirety herein for all purposes.

### BACKGROUND

Embodiments of the present invention relate to healthcare information systems, and in particular to a patient-governed healthcare information database environment.

Unless otherwise indicated herein, the approaches described in this section are not prior art to the claims in this application and are not admitted to be prior art by inclusion in this section.

At least three trends are emerging in the modern handling of healthcare within the United States. One trend is the attribution of health care information to the patient, rather than to particular institutions (i.e. providers) with whom the patient is affiliated. That is, a patient's healthcare information belongs to the patient, and only she is empowered to share that healthcare information with others.

A second trend recognizable within modern healthcare, is the fragmentation of medical care amongst many different specialist providers, including but not limited to hospitals, urgent care facilities, doctors, nurses, geneticists, nutritionists, pharmacists, HMOs, physical therapists, testing laboratories, dialysis centers, imaging centers, infusion centers, and others, to name only a few. And, with the oncoming proliferation of “smart” devices (e.g. blood sugar testers, diagnostic test kits, body weight scales, heart rate monitors, etc.) that are configured to communicate information in electronic form over the internet, the profusion of disparate sources of healthcare information is likely only to grow.

A third trend discernable within modern health care, is an increasing emphasis upon activities occurring outside of the formal healthcare milieu: that is, after a patient has been discharged from the hospital or is otherwise not under the direct supervision of a medical professional. Given the expense of such intensive care, greater emphasis is being placed upon the preventative (exercise, diet) and curative (e.g. medication intake) activities of the patient, as may often be monitored and/or supported by others in the community such as caregivers/relatives. Despite the often-important role played by this community, it is not necessarily assured that these other individuals will have access to the healthcare information of the patient.

Accordingly, the present disclosure addresses these and other issues with a patient-governed healthcare information database environment.

### SUMMARY

Embodiments relate to a patient-governed healthcare information database environment. The environment provides a central repository for receiving healthcare and related information of a particular individual patient, facilitating access by a plurality of authorized consumers (e.g. medical providers) of that information. The environment allows dynamic modification of the database to include many types of information, including data from smart devices, patient activity logs, and responses to customized assessments created by the patient or others. The environment also allows dynamic mining of database information according to flexible queries specifying parameters determined by the consumer of the healthcare information. Access to the environments of other patients may be granted, such that database modification permits data mining for patient cohorts sharing common characteristics. Some embodiments allow dynamic interaction between the environment and a provider, for example to issue an alert based upon database content (e.g. a medication log not timely updated), or for patient behavior modification via gamification techniques.

An embodiment of a computer-implemented method comprises providing a database comprising healthcare information of a patient, and causing an engine to add healthcare information of a plurality of other patients to the database. The engine is caused to mine the database based upon a query comprising a parameter, and to return a query result including healthcare information of the patient and healthcare information of a subset of the plurality of other patients satisfying the parameter, wherein the patient and the subset of the plurality of other patients define a cohort. The engine is caused to mine health information of the cohort within the database based upon a modified query, and caused to return a modified query result based upon the health information of the cohort.

An embodiment of a non-transitory computer readable storage medium embodies a computer program for performing a method comprising providing a database comprising healthcare information of a patient, and causing an engine to add healthcare information of a plurality of other patients to the database. The method further comprises causing the engine to mine the database based upon a query comprising a parameter, and causing the engine to return a query result including healthcare information of the patient and healthcare information of a subset of the plurality of other patients satisfying the parameter, wherein the patient and the subset of the plurality of other patients define a cohort. The method further comprises causing the engine to mine health information of the cohort within the database based upon a modified query, and causing the engine to return a modified query result based upon the health information of the cohort.

An embodiment of a computer system comprises one or more processors and a software program executable on said computer system. The software program is configured to provide a database comprising healthcare information of a patient, and cause an engine to add healthcare information of a plurality of other patients to the database. The software program is further configured to cause the engine to mine the database based upon a query comprising a parameter, and cause the engine to return a query result including healthcare information of the patient and healthcare information of a subset of the plurality of other patients satisfying the parameter, wherein the patient and the subset of the plurality of other patients define a cohort. The software program is further configured to cause the engine to mine health information of the cohort within the database based upon a modified query, and to cause the engine to return a modified query result based upon the health information of the cohort.

In certain embodiments the parameter is determined from an assessment.

According to some embodiments the parameter comprises a response to a question.

In various embodiments the parameter comprises a rating on a numerical scale.

Particular embodiments may further comprise dynamically changing the database to include an additional type of healthcare information.

In some embodiments the modified query references the additional type of healthcare information.

According to particular embodiments the healthcare information of the plurality of other patients is obtained in anonymous form from another database.

The following detailed description and accompanying drawings provide a better understanding of the nature and advantages of particular embodiments.

### BRIEF DESCRIPTION OF THE DRAWINGS

FIG. 1 shows a simplified view of one example of a patient-governed healthcare information database environment according to an environment.

FIG. 2 is a simplified view depicting dynamic aspects of a healthcare database environment according to various embodiments.

FIG. 2A is as simplified flow diagram illustrating steps in a method according to an embodiment.

FIGS. 3A-G show an example of creation of a cohort based upon assessment responses.

FIG. 4 is as simplified flow diagram illustrating steps in a method according to an embodiment.

FIG. 5 shows an example of dynamic interaction between a healthcare information database and a provider.

FIG. 5A is as simplified flow diagram illustrating steps in a method according to an embodiment.

FIG. 6 illustrates hardware of a special purpose computing machine configured to provide a healthcare database environment according to an embodiment.

FIG. 7 illustrates an example of a computer system.

### DETAILED DESCRIPTION

Described herein are techniques for implementing a patient-governed healthcare information database environment. The apparatuses, methods, and techniques described below may be implemented as a computer program (software) executing on one or more computers. The computer program may further be stored on a computer readable medium. The computer readable medium may include instructions for performing the processes described below.

In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

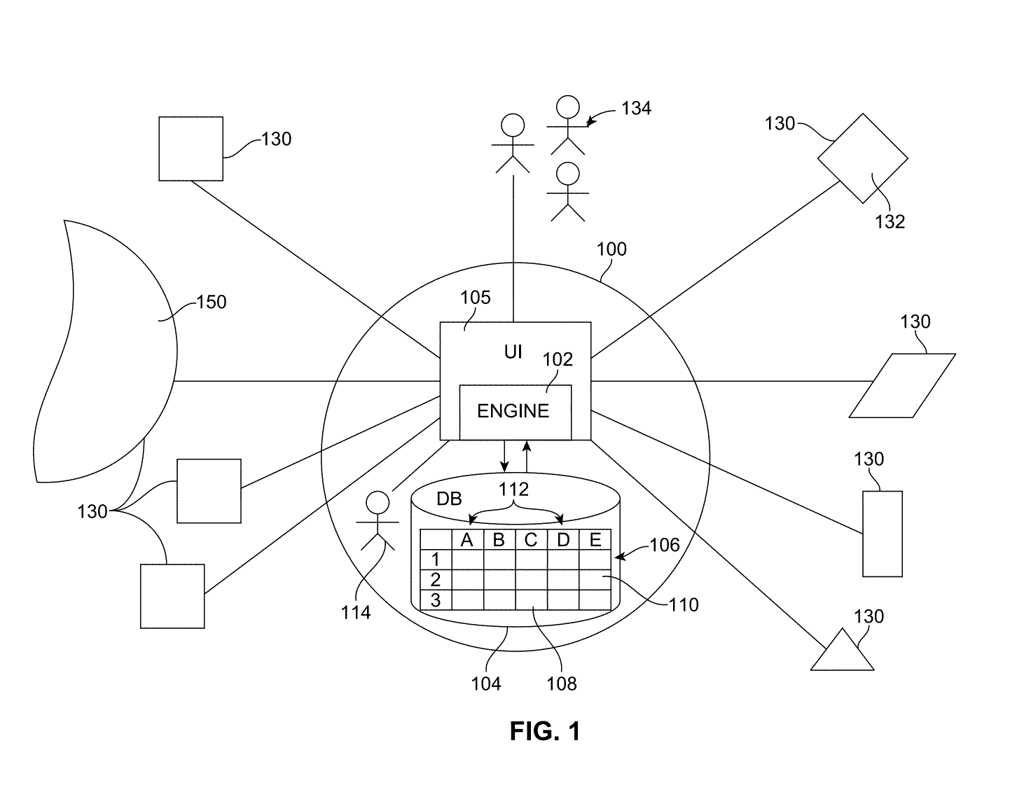

FIG. 1 shows a simplified view of one example of a patient-governed healthcare information database environment according to an environment. In particular, the environment 100 comprises an engine 102 that is in communication with a computer-readable storage medium 104 including healthcare information 106 that is contained within a database 108. Access to the engine by the patient 114 and by other outside entities is afforded through user interface (UI) 105.

It is noted that the database is not limited to being in any particular form or implementation. According to certain embodiments the database could comprise a conventional disk-based database.

Alternatively, the database could comprise an in-memory database. One example of such an in-memory database is the HANA database available from SAP AG. Other examples can include but are not limited to the SYBASE IQ database also available from SAP AG; the Microsoft Embedded SQL for C (ESQL/C) database available from Microsoft Corp. of Redmond, Wash.; and the Exalytics In-Memory database available from Oracle Corp. of Redwood Shores, Calif.

Similarly, for purposes of illustration only the healthcare information of the database 108 is shown as being organized into a plurality of rows 110 and columns 112. However this is not required, and depending upon the particular embodiment the database could be organized in various forms (e.g. as a tree, map, or some other schema).

As an initial matter, it is noted that the database may be initially populated with the types of data that are conventionally associated with health care. Examples of such data types are legion, but typically include the patient name, residence, contact information, identification numbers (e.g. a social security no. issued by the federal government, a driver's license issued by a state government, a health plan number issued by a HMO, a patient ID issued by a particular provider etc.), patient vital statistics, diagnosed conditions of the patient, allergies, past medical history, test results, prescribed medications, and many others.

As noted throughout the instant disclosure, however, a healthcare database environment according to embodiments may exhibit a dynamic character that allows it to store and assimilate virtually any other type of information as instructed by the patient or by another entity authorized by the patient. One example of this dynamism is where a patient with diabetes specifically instructs the database to receive and store blood sugar information acquired from a blood sugar tester. Another example of this dynamism is that a caregiver granted access by the patient, may specifically instruct the database to include particular medication information, such as a log tracking the date, time, and/or dosage of particular medications administered. The dynamic aspects of the database environment according to various embodiments as disclosed herein, are discussed further below.

FIG. 1 also shows the patient 114 herself as being present within the environment 100. The patient is in communication with the processor 102 to access all information stored in the database. According to particular embodiments, the processor and/or database may be stored remotely from the patient on a server, with the patient interacting with the processor via a network connection.

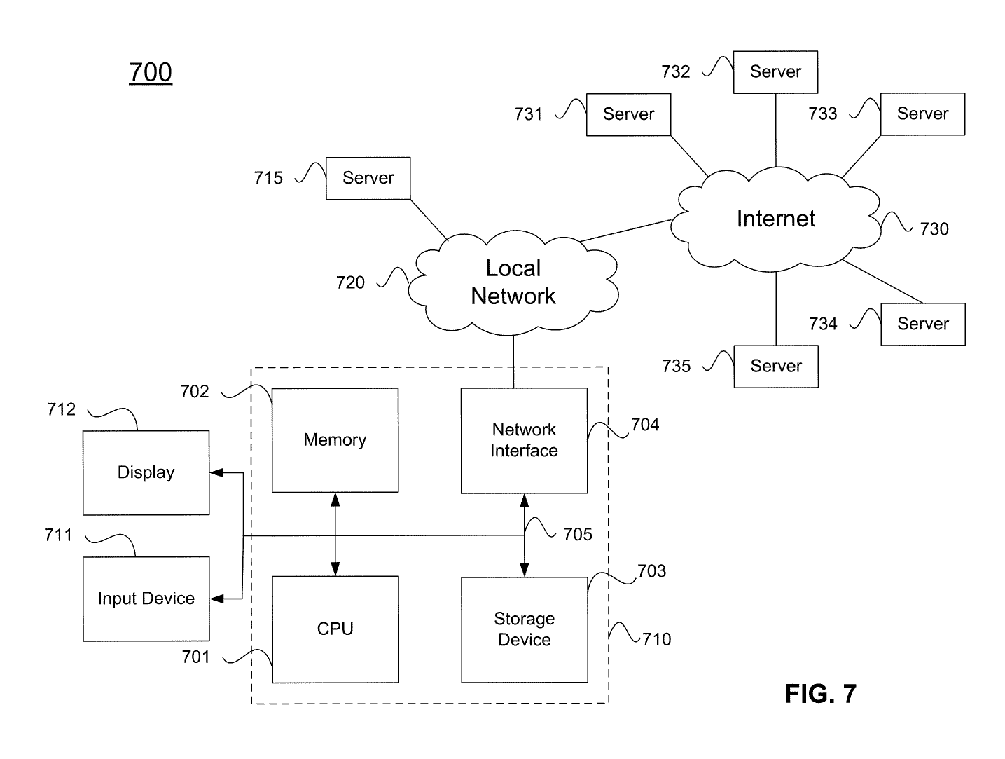

FIG. 7 below provides a general description of a computer system and environment through which healthcare information of a database may be accessed and modified. As emphasized herein, a database environment according to an embodiment may be governed by the patient rather than by a health care provider. Accordingly, the database and/or the engine may be hosted on a remote server administered by a third party rather than by a healthcare provider.

As mentioned above, the patient is primary possessor or her healthcare information. The patient, however, is empowered to grant permission for other entities to have access to all or some subset of that healthcare information. FIG. 1 thus also shows a plurality of entities 130 having access to the healthcare database information via the processor.

These entities 130 can be of many types. Of course one traditional type of entity would be the patient's primary care provider 132, for example the Health Maintenance Organization (HMO) to which the patient belongs.

Other of the entities 130, however, may lie outside of the HMO. One example of such an entity is a caregiver 134 (or a community of caregivers) of the patient, for example a relative, friend, or other individual who is informally assisting the patient at home with her care. As mentioned above, such community resources may play an indispensable role in helping the patient address and overcome relevant medical conditions, yet they are often overlooked by conventional healthcare information services.

Other examples of entities lying outside the patient's HMO can include but are not limited to pharmacies, physical/occupational therapists, laboratories, imaging centers, home nursing staffs, etc. As described in detail below, each of these entities may serve as a source and/or a consumer of the healthcare information that is stored in the database environment.

It is further noted that with the consent of the patient, the environment 100 may even be in communication with the corresponding healthcare database environment(s) 150 that are governed by other patients. In certain instances, full access to the environment 150 and the healthcare information present therein, may be available to the patient environment 100. However this is not required and in other embodiments only limited access (e.g. in anonymous form) to only a part of a patient's available healthcare database information, could be made available for sharing. One example of an implementation leveraging this dynamic nature of the database environment, is now discussed in detail in connection with the creation and modification of a patient cohort.

### Example

### Patient Cohort Creation

The dynamism offered by a healthcare database environments according embodiments, may offer significant benefits. One possible benefit is enhanced freedom and flexibility in creating and then accessing and exploring available healthcare data, for example in connection with advanced data mining techniques.

Returning to FIG. 1, that view shows the healthcare database as comprising a plurality of rows and columns. In a highly simplified case, the patient might be represented by a row, with the various columns corresponding to particular pieces of health care data relevant to the patient. For example, column A could contain the patient's name, column B could identify the patient's latest major medical treatment, etc.

Far from containing only these traditional types of healthcare information, however, as emphasized above the database according to certain embodiments is dynamic rather than static. The database can be readily modified to include more columns (or rows) receiving additional types of healthcare information.

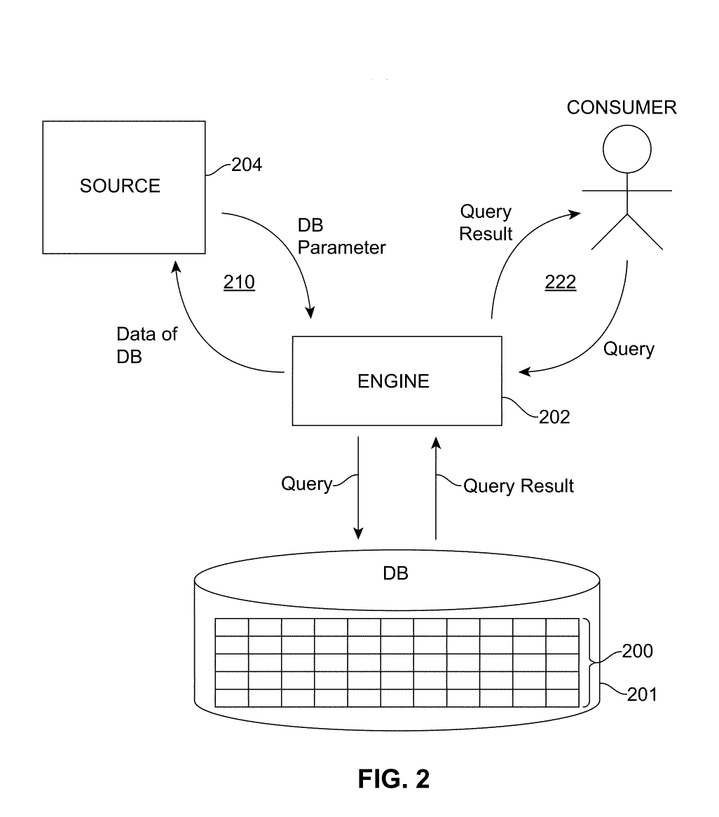

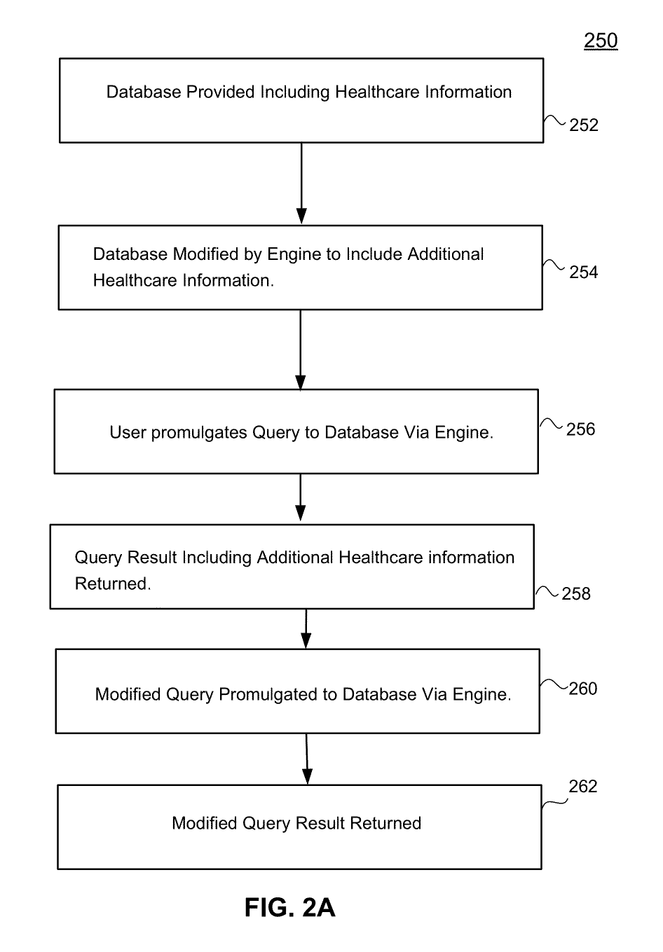

FIG. 2 is a simplified view depicting this dynamic aspect of the healthcare database environment according to various embodiments. In particular, FIG. 2 shows a database 200 within the non-transitory computer-readable storage medium 201 as being in communication with an engine 202 to receive healthcare information from a particular source 204. As previously mentioned, such a source can include the patient's primary care physician, or can include non-traditional sources such as community caregivers, or even smart electronic devices.

One aspect of the dynamism provided according to certain embodiments, is shown in the nature of the interaction 210 between the data source and the database. That is, the database is readily modified according to instructions received by the engine, in order to accommodate new types of healthcare information that may be available from a source. In certain embodiments, the database could be changed to include additional column(s) and/or row(s) receiving such information.

A wide variety of additional information that may be relevant to a patient's health, could be added to the database. Particular examples include intangible condition information such as mood or energy level, which could be quantified by rating on a numerical scale and then tracked over time. Such additional information could be provided to the database in the form of responses to an assessment document, the content of which could be created by the patient herself, or others as authorized by the patient.

Conversely, the database is also readily modified according to instructions received by the engine to remove types of healthcare information. An example of this might be where a user updates her blood sugar monitor to a new model outputting data in a new format, such that data in the antiquated format is no longer to be supported in the database.

FIG. 2 also shows the database 200 within the non-transitory computer-readable storage medium 201 as being in communication with the engine 202 to supply healthcare information to a consumer 220. As used herein, “consumer” refers to any entity seeking to access, review, analyze, and/or change healthcare information stored in the patient-governed database environment. As previously mentioned, one such consumer could be the patient herself. Another possible traditional consumer would be the patient's primary care physician. Still another possible consumer could be non-traditional, for example a community caregiver for the patient.

Another aspect of the dynamism exhibited according to certain embodiments, is illustrated in the interaction 222 occurring between the database and the consumer of the healthcare information. That is, the engine is poised to receive and provide relevant information in response to inquiries (e.g. queries) formulated in a flexible manner by the consumer. That is, a consumer may formulate and promulgate queries to the database relating to a wide array of healthcare information types available in the database. In some embodiments these queries may be highly sophisticated, specific, and detailed, as allowed by the dynamic structure of the underlying database and refined data mining techniques that have been developed. The engine promulgates such queries to the database, and in return receives the relevant query results.

The environment is designed to encourage an iterative and dynamic exploration of healthcare information available in the database. That is, based upon an analysis of a query result, the engine could be configured to promulgate a modified query to the database to return further information which may be of use to a consumer. One example of such an iterative interrogation of information in a healthcare database environment, is described further below in connection with the creation of patient cohorts.

FIG. 2A is a simplified flow diagram illustrating steps of a method 250 employing a healthcare database environment according to an environment. In a first step 252 a database is provided including healthcare information. In a second step 254 the database is modified by an engine to include additional healthcare information. In a third step 256 a user promulgates a query to the database via the engine. In a fourth step 258 a query result including the additional healthcare information is returned. In a fifth step 260 a modified query is promulgated to the database via the engine. In a sixth step 262 a modified query result is returned.

Returning to the source-database interaction illustrated on the left side of FIG. 2, one particular source of additional information for dynamically incorporation within the database, could be the patient herself (or a caregiver to the patient). In particular embodiments this healthcare information could be reported in the form of responses to specific questions contained in an assessment document.

Far from containing only traditional types of healthcare information, however, Such assessment responses could be utilized to gain further insight into the status of the patient relative to larger patient group(s) having different attributes and characteristics. These larger patient groupings are hereinafter referred to as cohorts.

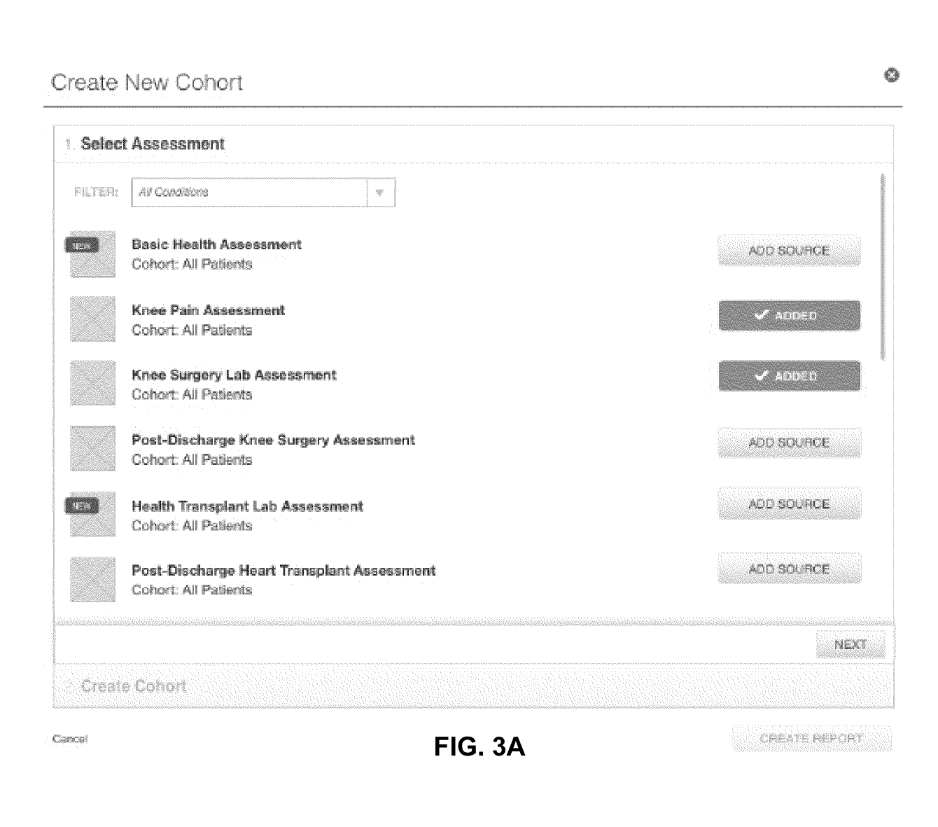

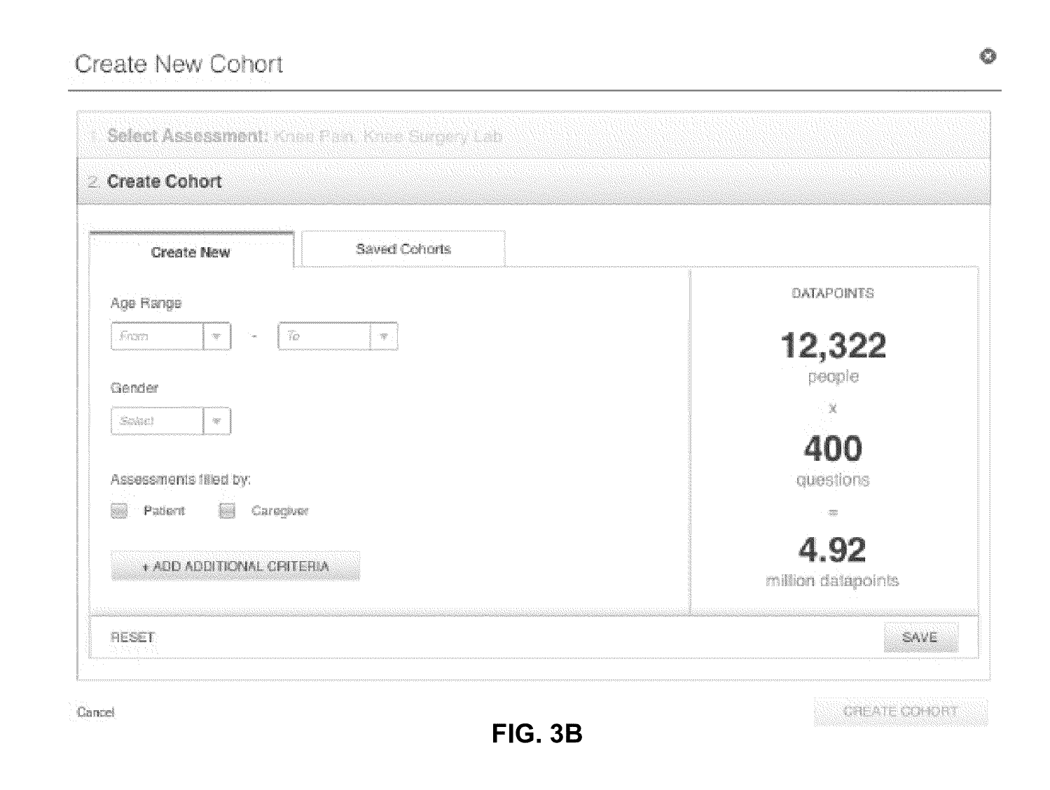

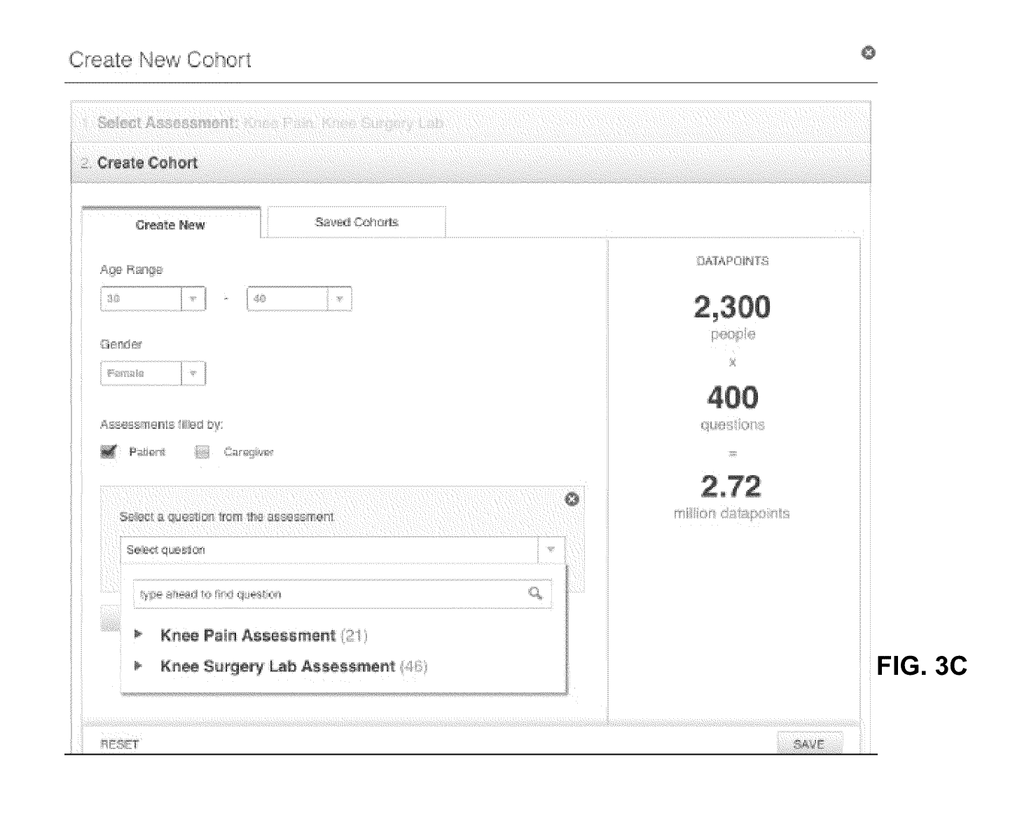

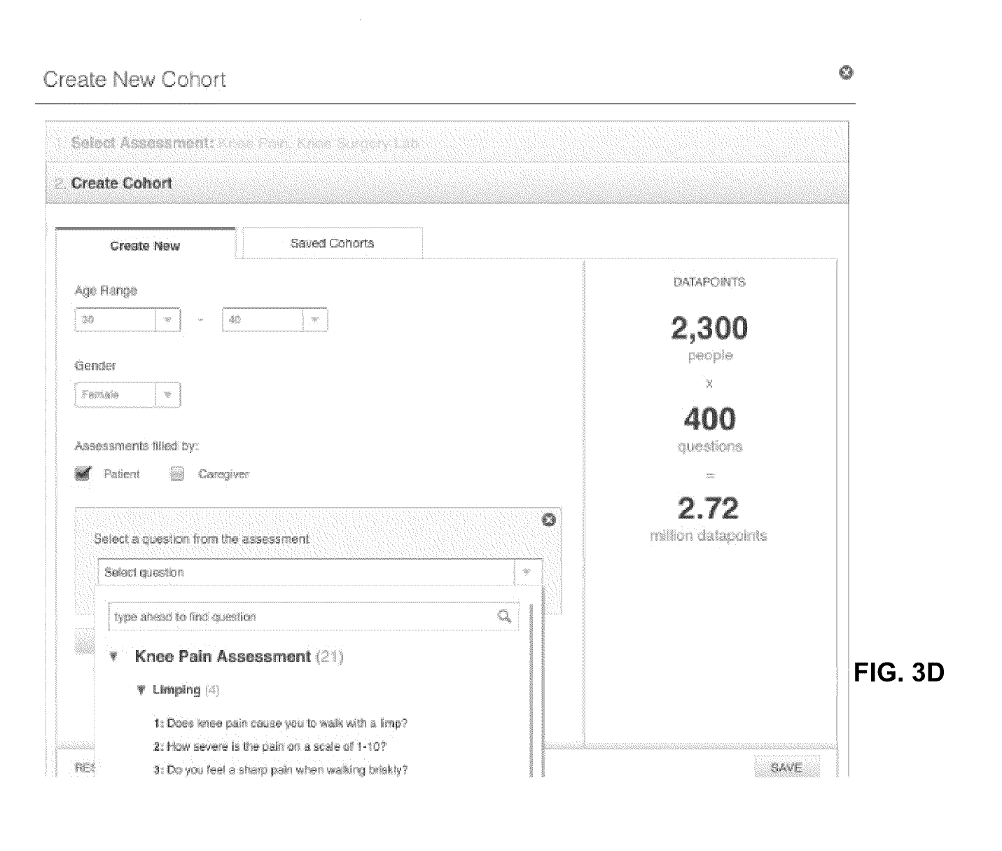

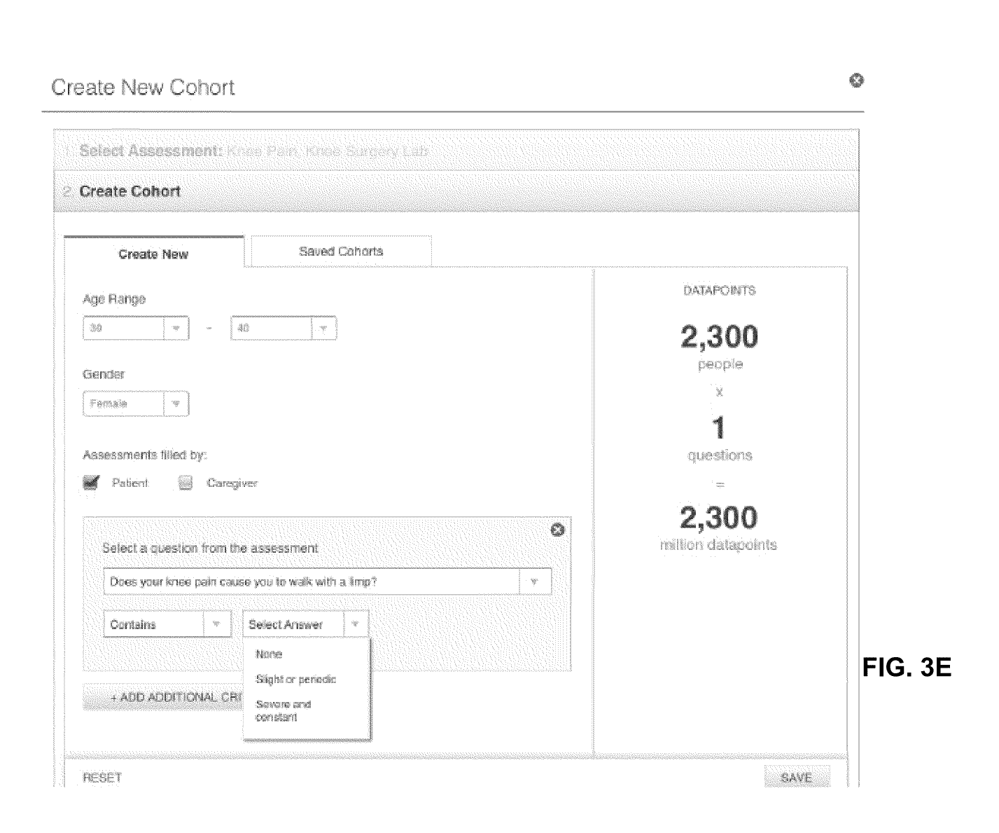

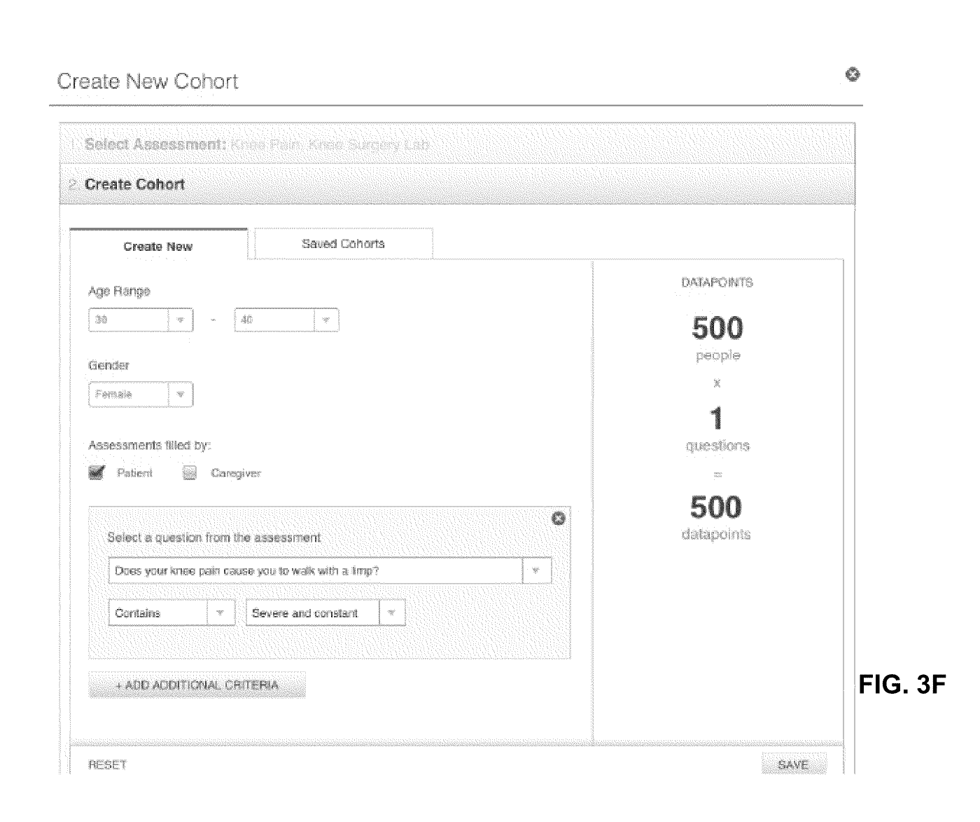

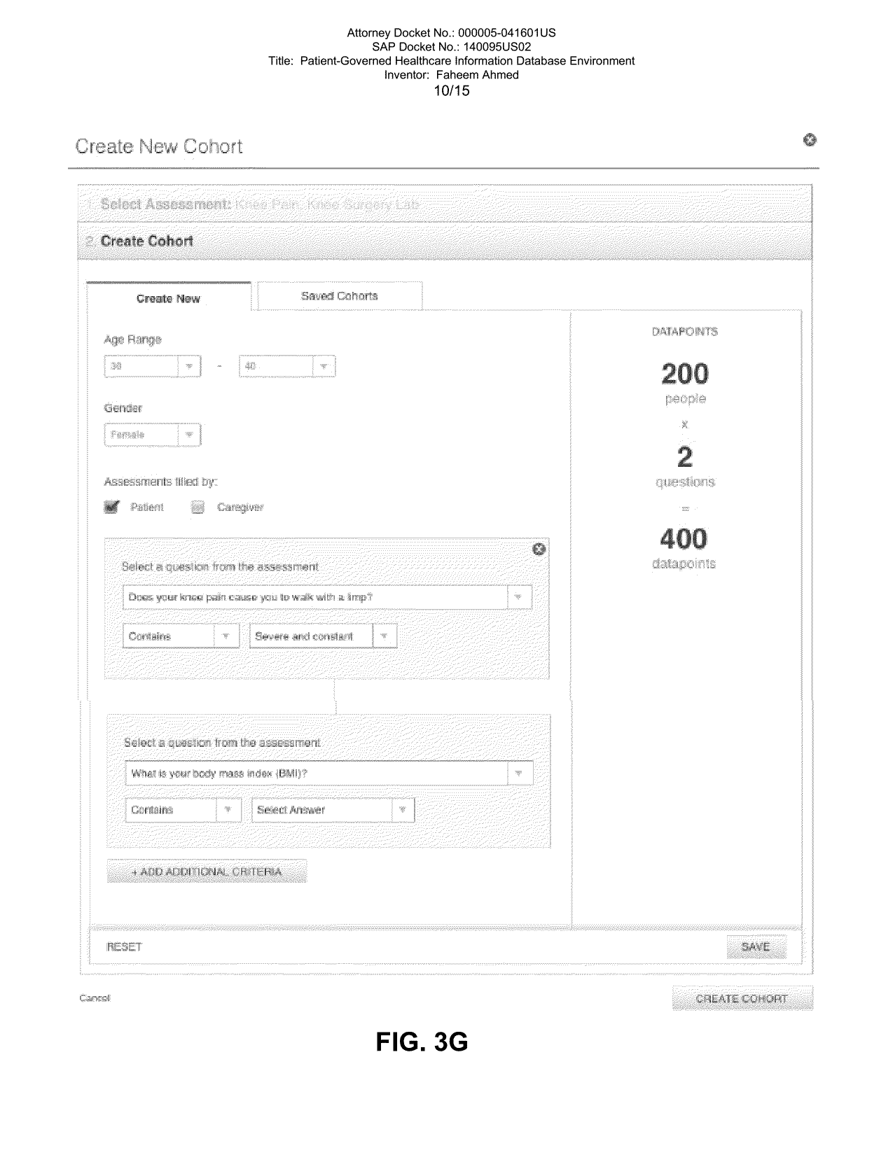

The screen shots of FIGS. 3A-G show an example of creation of a cohort based upon assessment responses. This example assumes that the patient who is the subject of the healthcare database environment, has had knee replacement surgery.

FIG. 3A shows a list of known previous assessments which are available for storing within the database environment. Certain of these assessments are general in nature (e.g. “Basic Health Assessment”). Certain of these assessments are specifically targeted to knee issues (e.g. “Knee Pain Assessment”; “Knee Surgery Lab Assessment”; “Post Discharge Knee Surgery Assessment”). Other assessments are targeted to other specific topics (e.g. “Health Transplant Lab Assessment”; “Post-Discharge Heart Transplant Assessment”). Accordingly, FIG. 3A shows the user selection of two of the most relevant assessments.

FIG. 3B shows details of an original cohort of patients (“All Patients”) for which any assessment information is available. In some embodiments, depending upon availability and patient consent, this original cohort could be limited to all patients of only one specific provider (e.g. HMO). However this is not required, and the standardization, interoperability, and anonymity afforded by healthcare database environments according to embodiments could also allow for the inclusion of patients in the original cohort from other providers.

FIG. 3B lists specific characteristics of the original “All Patients” cohort. This cohort comprises assessment responses available from 12,322 people (patients and caregivers) providing answers to a total of 400 assessment questions, resulting in a total volume of data points of 4.92 million.

The sheer size and generality of the information of this large original cohort can swamp the consumer and undesirably mask information contained therein that is relevant to the particular patient. Thus according to embodiments, creation of a new, more specific cohort could prove useful in drawing out that relevant information.

Accordingly, the following FIGS. 3C-3G show the mining of the large volume of healthcare data by the creation of a new, specific cohort. In particular, the newly created cohort initially refines the original cohort by specifying (self)-assessment information taken from the patient only, rather than from others such as a caregiver. Also specified is a patient age range (30-40 years) and a patient gender (female). This results in a reduction in the data volume to 2.72 million datapoints: 2,300 patients×400 self-assessment questions apiece.

The interface to the processor then offers the user the option of dynamically selecting particular assessment information in order to further refine the cohort. This is shown in FIG. 3C, where the database environment suggests the user to select particular available assessments (“Knee Pain Assessment”; “Knee Surgery Lab Assessment”) that are known to be directly relevant to the patient's current condition (knee replacement).

As shown in FIGS. 3C-3D, successive user selection of a particular assessment (“Knee Pain Assessment”), and one particular question (walking with a limp?) within that assessment, significantly narrows the data volume (to 2300 datapoints). FIGS. 3E-3F shows that user selection of a specific answer to the question (“Severe and constant”) further narrows the cohort to 500 patients (i.e., 500 of the female patients between 30-40 years of age responded to this self-assessment with this answer), and to the same number of datapoints.

FIG. 3G shows that the dynamic healthcare database environment offered by particular embodiments offers even further possible refinement of the cohort. In particular, data mining techniques available to the environment allow a consumer to further select for a cohort with patients also providing a response with body mass index (BMI) information. This reduces the population of the cohort from 500 to 200, and the data volume from 500 to 400: 200 patients×2 questions apiece.

Thus as described herein, the generation of a cohort can provide a focused, relevant, pool of data allowing comparison and exploration of the state of the current patient relative to others under similar conditions. This data mining can help predict probable outcomes, and under some circumstances could even possibly identify systemic defects arising in care procedures giving rise to unfavorable outcomes. That is, useful patterns of healthcare data may emerge to a consumer based upon refinement of the cohort.

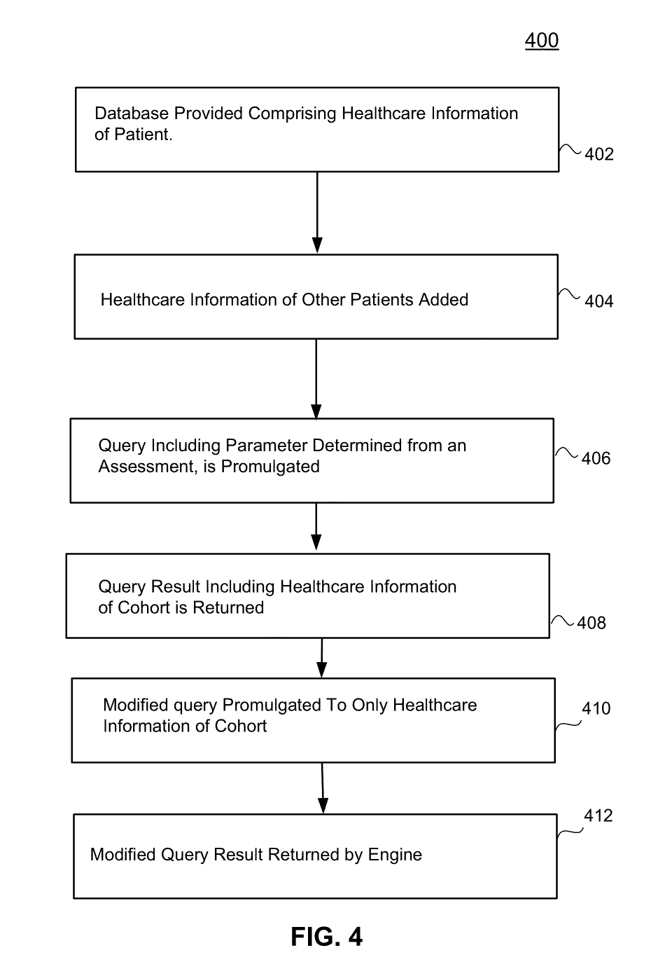

FIG. 4 is as simplified flow diagram illustrating steps in a method 400 according to one embodiment. In a first step 402, a database is provided comprising healthcare information of a patient. In a second step 404, healthcare information of a plurality of other patients is added to the database by an engine. In a third step 406, a query including a parameter determined from an assessment, is promulgated to the database by the engine. In a fourth step 408, a query result including healthcare information of the patient and healthcare information of a subset of the plurality of other patients is returned by the engine, wherein the patient and the plurality of other patients define a cohort. In a fifth step 410, a modified query is promulgated by the engine to only the health information of the cohort in the database. In a sixth step 412, a modified query result is returned by the engine.

### Example

### Dynamic Consumer Interaction

Another possible benefit of the dynamism offered by the healthcare database environment of various embodiments, is interoperability. That is, rather than being captive in a location and to a format (often antiquated) governed exclusively by the dictates of a single provider (e.g. the HMO), healthcare information relevant to a patient's well-being may now be available to all of the other entities on an equal footing, in a commonly accessible format (e.g. via the user interface to the processor). This removes often artificial barriers to central collection of relevant healthcare information (e.g. due to red tape), thereby expanding the scope of the knowledge available to the patient and to those authorized to access the information on the patient's behalf.

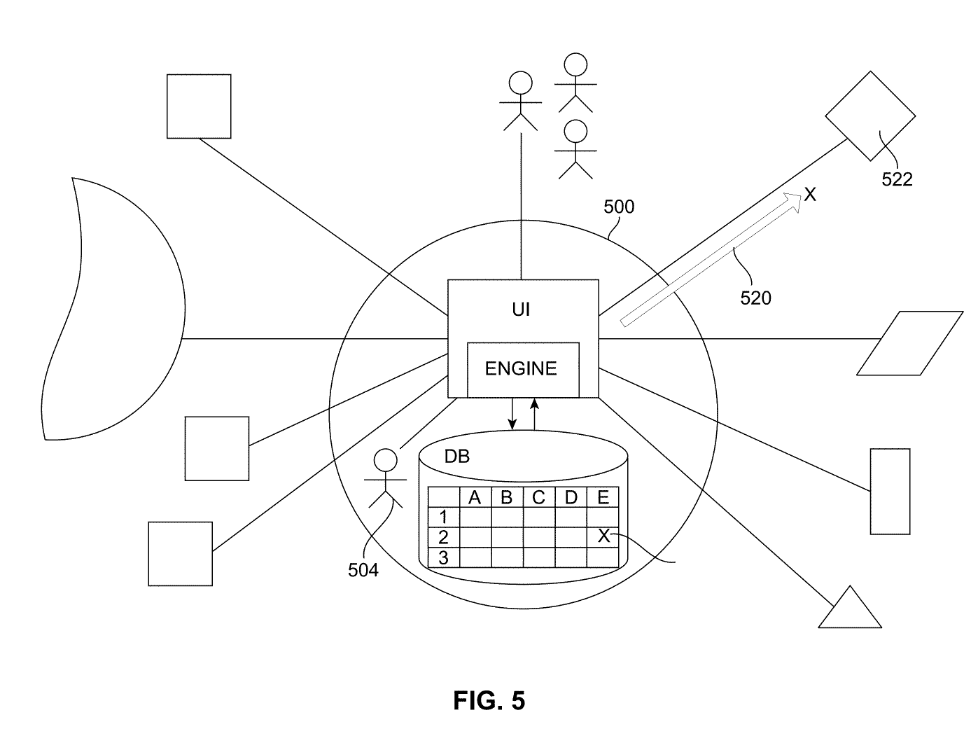

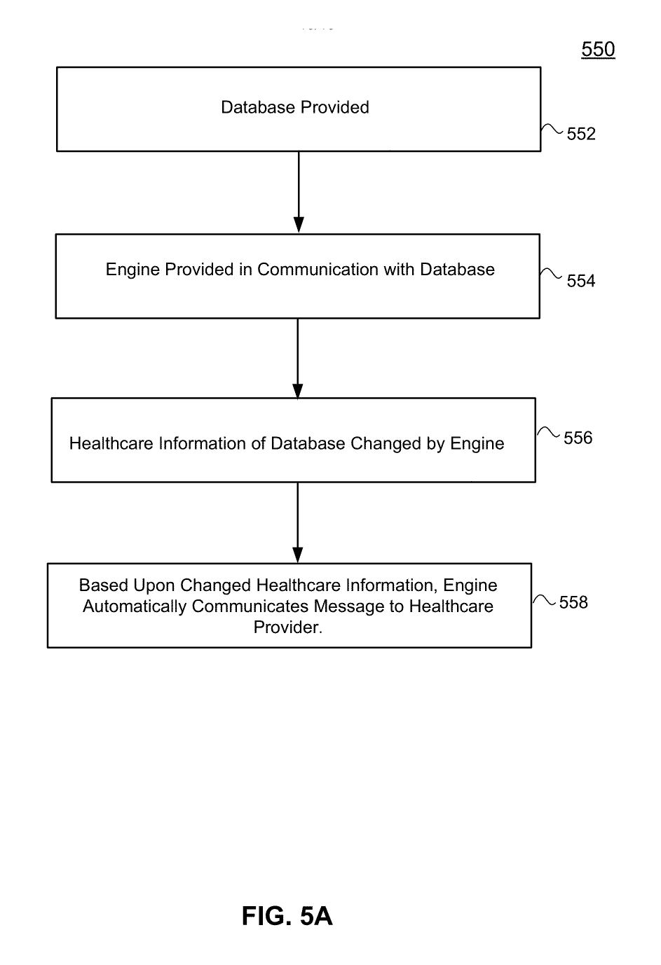

Under certain circumstances, such interoperability may allow the healthcare information database to engage in a dynamic relationship with a consumer (such as a provider). FIG. 5 illustrates one example of such a dynamic relationship.

In particular, healthcare database environment 500 may be configured to store specific information 502 regarding daily blood sugar measurements by the patient 504. As previously described, the environment may allow this information to be entered by the patient herself, or by a caregiver or a community thereof. In certain embodiments the database can readily be modified in a dynamic manner to accept data in a particular format over the internet from a smart blood sugar testing device.

Based upon specific instructions to be executed by the engine, the engine may be configured to report 520 on a periodic basis, the blood sugar reading of the database to an authorized outside provider 522 such as the patient's primary care physician or a nursing staff. Depending upon the specific embodiment, this reporting could be driven by the engine (push), or occur in response to polling by the provider (pull). Based upon the provider having access to this blood sugar information, alerts could be issued allowing the provider to take steps quickly addressing issues before they escalate into conditions of greater seriousness.

According to still other embodiments, the environment itself could leverage the dynamic nature of the provider interaction in order to take the active role in place of the provider. That is, the engine could include instructions to automatically issue an alert to the provider based upon blood sugar data present within the database. And, as mentioned previously, the patient herself could be allowed to establish both the specific storage of blood sugar information within the database, and the handling of that information by the engine.

Moreover, the dynamic role of the database environment is not limited to monitoring conditions, communicating data to providers, and/or issuing alerts. According to some embodiments, by providing the data in the database and an engine configured to access same, the environment could play a role in preventative healthcare approaches.

For example, healthcare information of the database could be employed in a gamification context to encourage positive patient behavior. Working with the primary care physician, the patient could formulate a desired regular pattern of conduct (e.g. exercise routine, nutrition regimen), compliance with which could be rewarded in a tangible way. The database would allow tracking of patient behavior, and the engine could provide rewards in the form of positive stimuli to the patient, as devised by the patient herself.

FIG. 5A is as simplified flow diagram illustrating steps in a method 550 according to one embodiment. In a first step 552, a database is provided comprising healthcare information of a patient. In a second step 554, an engine is provided in communication with the database. In a third step 556, healthcare information of the database is changed by the engine. In a fourth step 558, based upon the changed healthcare information, the engine automatically communicates a message to a healthcare provider.

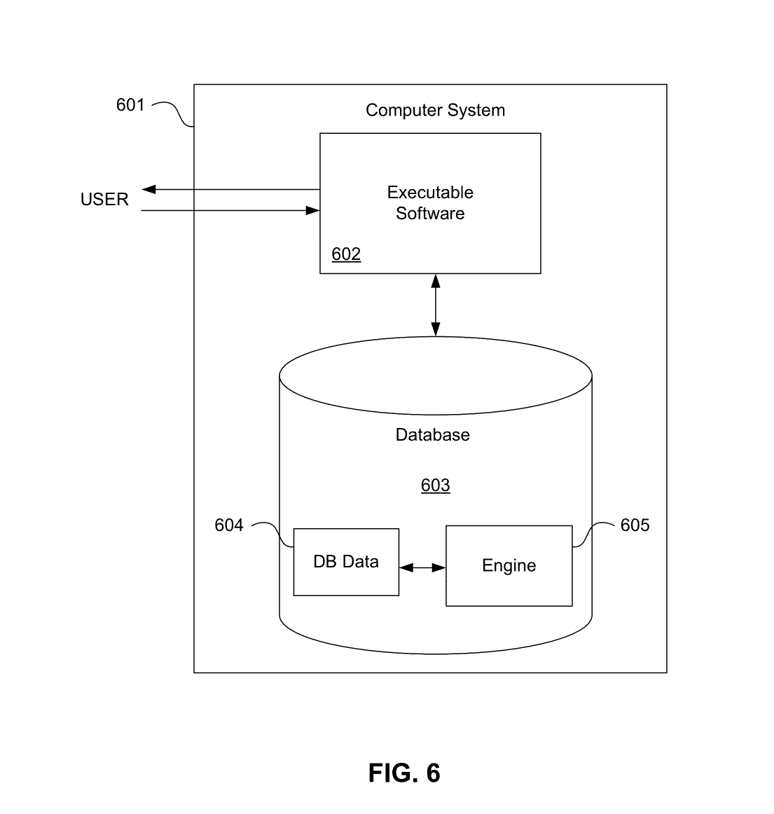

FIG. 6 illustrates hardware of a special purpose computing machine configured to provide a healthcare information database environment according to an embodiment. In particular, computer system 600 comprises a processor 602 that is in electronic communication with a non-transitory computer-readable storage medium 603. This computer-readable storage medium has stored thereon code 605 corresponding to an engine. Code 604 corresponds to healthcare information within the database. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

An example computer system 710 is illustrated in FIG. 7. Computer system 710 includes a bus 705 or other communication mechanism for communicating information, and a processor 701 coupled with bus 705 for processing information. Computer system 710 also includes a memory 702 coupled to bus 705 for storing information and instructions to be executed by processor 701, including information and instructions for performing the techniques described above, for example. This memory may also be used for storing variables or other intermediate information during execution of instructions to be executed by processor 701. Possible implementations of this memory may be, but are not limited to, random access memory (RAM), read only memory (ROM), or both. A storage device 703 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 703 may include source code, binary code, or software files for performing the techniques above, for example. Storage device and memory are both examples of computer readable mediums.

Computer system 710 may be coupled via bus 705 to a display 712, such as a cathode ray tube (CRT) or liquid crystal display (LCD), for displaying information to a computer user. An input device 711 such as a keyboard and/or mouse is coupled to bus 705 for communicating information and command selections from the user to processor 701. The combination of these components allows the user to communicate with the system. In some systems, bus 705 may be divided into multiple specialized buses.

Computer system 710 also includes a network interface 804 coupled with bus 805. Network interface 704 may provide two-way data communication between computer system 710 and the local network 720. The network interface 704 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 704 sends and receives electrical, electromagnetic, or optical signals that carry digital data streams representing various types of information.

Computer system 710 can send and receive information, including messages or other interface actions, through the network interface 704 across a local network 720, an Intranet, or the Internet 730. For a local network, computer system 710 may communicate with a plurality of other computer machines, such as server 715. Accordingly, computer system 710 and server computer systems represented by server 715 may form a cloud computing network, which may be programmed with processes described herein. In the Internet example, software components or services may reside on multiple different computer systems 710 or servers 731-735 across the network. The processes described above may be implemented on one or more servers, for example. A server 731 may transmit actions or messages from one component, through Internet 730, local network 720, and network interface 704 to a component on computer system 710. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
providing a database comprising healthcare information of a patient;
causing an engine to add healthcare information of a plurality of other patients to the database;
causing the engine to mine the database based upon a query comprising a parameter;
causing the engine to return a query result including healthcare information of the patient and healthcare information of a subset of the plurality of other patients satisfying the parameter, wherein the patient and the subset of the plurality of other patients define a cohort;
causing the engine to mine health information of the cohort within the database based upon a modified query; and
causing the engine to return a modified query result based upon the health information of the cohort.

2. A method as in claim 1 wherein the parameter is determined from an assessment.

3. A method as in claim 2 wherein the parameter comprises a response to a question.

4. A method as in claim 2 wherein the parameter comprises a rating on a numerical scale.

5. A method as in claim 1 further comprising dynamically changing the database to include an additional type of healthcare information.

6. A method as in claim 5 wherein the modified query references the additional type of healthcare information.

7. A method as in claim 1 wherein the healthcare information of the plurality of other patients is obtained in anonymous form from another database.

8. A non-transitory computer readable storage medium embodying a computer program for performing a method, said method comprising:
providing a database comprising healthcare information of a patient;
causing an engine to add healthcare information of a plurality of other patients to the database;
causing the engine to mine the database based upon a query comprising a parameter;
causing the engine to return a query result including healthcare information of the patient and healthcare information of a subset of the plurality of other patients satisfying the parameter, wherein the patient and the subset of the plurality of other patients define a cohort;
causing the engine to mine health information of the cohort within the database based upon a modified query; and
causing the engine to return a modified query result based upon the health information of the cohort.

9. A non-transitory computer readable storage medium as in claim 8 wherein the parameter is determined from an assessment.

10. A non-transitory computer readable storage medium as in claim 9 wherein the parameter comprises a response to a question.

11. A non-transitory computer readable storage medium as in claim 9 wherein the parameter comprises a rating on a numerical scale.

12. A non-transitory computer readable storage medium as in claim 8 wherein the method further comprises dynamically changing the database to include an additional type of healthcare information.

13. A non-transitory computer readable storage medium as in claim 12 wherein the modified query references the additional type of healthcare information.

14. A non-transitory computer readable storage medium as in claim 8 wherein the healthcare information of the plurality of other patients is obtained in anonymous form from another database.

15. A computer system comprising:
one or more processors;
a software program, executable on said computer system, the software program configured to:
provide a database comprising healthcare information of a patient;
cause an engine to add healthcare information of a plurality of other patients to the database;
cause the engine to mine the database based upon a query comprising a parameter;
cause the engine to return a query result including healthcare information of the patient and healthcare information of a subset of the plurality of other patients satisfying the parameter, wherein the patient and the subset of the plurality of other patients define a cohort;
cause the engine to mine health information of the cohort within the database based upon a modified query; and
cause the engine to return a modified query result based upon the health information of the cohort.

16. A computer system as in claim 15 wherein the parameter is determined from an assessment.

17. A computer system as in claim 16 wherein the parameter comprises a response to a question.

18. A computer system as in claim 16 wherein the parameter comprises a rating on a numerical scale.

19. A computer system as in claim 15 wherein the software program is further configured to dynamically change the database to include an additional type of healthcare information.

20. A computer system as in claim 19 wherein the modified query references the additional type of healthcare information.
